(19) United States
(12) Patent Application Publication
(10) Pub. No.: US 2017/0060054 A1
(43) Pub. Date: Mar. 2, 2017

(54) CENTER REGISTERED PROCESS DIRECTION HEATING ELEMENT WITH TEMPERATURE LEVELING AND/OR RESISTANCE INCREASE

(71) Applicant: XEROX CORPORATION, Norwalk, CT (US)

(72) Inventors: Tab A. TRESS, Henrietta, NY (US); Christopher A. JENSEN, Portland, OR (US); Brian J. GILLIS, Penfield, NY (US)

(21) Appl. No.: 14/838,005

(22) Filed: Aug. 27, 2015

(51) Int. Cl. G03G 15/20

(52) U.S. Cl. CPC G03G 15/2053

(57) ABSTRACT

Accordingly, an improved fuser is disclosed that includes a heater which provides uniformity at the surface of the fuser that contacts an imaged sheet by configuring a new heating element consisting of a resistive trace flanked by conductive paths on either side in the process direction. On one end of the resistive trace is a single continuous conductive trace referred to as the common. On the other end resistive trace are three or more separate conductive traces to allow heating for different paper widths. The resistive trace is augmented with dielectric circles to increase the overall resistivity of the heating element. Rows of dielectric can be offset from one another to insure overall thermal uniformity.

### BACKGROUND OF THE INVENTION

This invention relates generally to electrostatographic reproduction machines, and more particularly, to a fuser adapted to handle multiple paper widths and is especially useful in center registered machines.

In electrostatographic printing, commonly known as xerographic or printing or copying, an important process step is known as “fusing”. In the fusing step of the xerographic process, dry marking making material, such as toner, which has been placed in imagewise fashion on an imaging substrate, such as a sheet of paper, is subjected to heat and/or pressure in order to melt the otherwise fuse the toner permanently on the substrate. In this way, durable, non-smudging images are rendered on the substrates.

The most common design of a fusing apparatus as used in commercial printers includes two rolls, typically called a fuser roll and a pressure roll, forming a nip therebetween for the passage of the substrate therethrough. Typically, the fuser roll further includes, disposed on the interior thereof, one or more heating elements, which radiate heat in response to a current being passed therethrough. The heat from the heating elements passes through the surface of the fuser roll, which in turn contacts the side of the substrate having the image to be fused, so that a combination of heat and pressure successfully fuses the image. One configuration for radiating heat is a resistive heater that is adapted for heating a fuser belt with the heater comprising overlapping substrates, i.e., a first resistive trace formed over the substrate, and a second resistive trace formed so as to at least partially overlap the first trace. In some instances heating inside the roll is done to take into account the fact that a sheet of a particular size is being fed through the nip. One configuration for radiating heat inside the fuser roll is to use parallel lamp configured to heat a heating-producing material along with a number of smaller portions of heat-producing material with all being connected in series. In this way one can selectively heat different parts of the heat producing material so as to as to create a variable heating pattern. This particular configuration of heating elements within each lamp will have a relatively hot and relatively cold end. That is, when electrical power is applied to either lamp, one end of the lamp will largely generate more heat that the other end of the lamp and as a consequence there are areas there will be images that are not properly fused to the media.

In centered register machines, the heating element is a heating board with a trident shaped heat generating layer that is arranged into branch electric passages for limiting the heat generating regions in a cross process direction of the direction of travel of the media. The electric passages are created and/or maintained by using multiple heating traces or by using inter heating trace conductive taps. The creation of such passages requires the use of multiple drawer connectors and multiple voltages. For example, in the case of a centered register machine wishing to accommodate a four (4) distinct paper sizes would require eight (8) drawer connectors and four (4) voltage sources.

Multiple heating traces have been shown to hurt heat transfer performance and thus extendibility. Designs with inter heating trace conductive taps have cold spots that effect hurt latitudes and require bigger drawer connectors with extra pins. Present center registered single heating trace designs require either serial control or perfect knowledge of media widths.

For the reasons stated above, and for other reasons stated below which will become apparent to those skilled in the art upon reading and understanding the present specification, there is a need in the art for new heating element design in electrostatographic printing to provide a single heating trace design with a minimal drawer connector and a single voltage to be used across the element at all locations providing heating to sheet of varying sizes that may be fed through the nip. There is also a need for improved independent control of a heating element.

### BRIEF SUMMARY OF THE INVENTION

Accordingly, an improved fuser is disclosed that includes a heater which provides uniformity at the surface of the fuser that contacts an imaged sheet by configuring a new heating element consisting of a resistive trace flanked by conductive paths on either side in the process direction. On one end of the resistive trace is a single continuous conductive trace referred to as the common. On the other end resistive trace are three or more separate conductive traces to allow heating for different paper widths. The resistive trace is augmented with dielectric circles to increase the overall resistivity of the heating element. Rows of dielectric can be offset from one another to insure overall thermal uniformity.

### BRIEF DESCRIPTION OF THE DRAWINGS

FIG. 1 is an elevational view showing relevant elements of an exemplary toner imaging electrostatographic machine including a first embodiment of the fusing apparatus of the present disclosure;

FIG. 2 is an enlarged schematic end view of the fusing apparatus of FIG. 1;

FIG. 3A is partial plan view of the heater portion of the first embodiment of the improved fuser of FIG. 2 that employs a independently controllable resistive trace flanked by conductive paths on either side in the process direction;

FIG. 3B is a schematic of a resistive trace flanked by conductive paths on either side in the process direction in accordance to an embodiment;

FIG. 4 is partial plan view of the heater portion of a single resistive trace having segments of same or varying resistance to heat different paper widths in accordance to an embodiment;

FIG. 5 is partial plan view of the heater portion of a single resistive trace infused with a dielectric to increase overall resistance in accordance to an embodiment;

FIG. 6 is partial plan view of the heater portion of a single resistive trace infused with a dielectric at the top and bottom of the heating zone to increase overall resistance in accordance to an embodiment; single high voltage level;

FIG. 7 is partial plan view of the heater portion of a single resistive trace infused with a dielectric configured to produce single high voltage level in accordance to an embodiment;

FIG. 8 illustrates a flowchart of a method to control heat generating segments of the resistive trace in accordance to an embodiment.

### DETAILED DESCRIPTION OF THE INVENTION

Illustrative examples of the devices, systems, and methods disclosed herein are provided below. An embodiment of the devices, systems, and methods may include any one or more, and any combination of, the examples described below.

Example 1 includes a xerographic device adapted to print an image onto a copy sheet, comprising an imaging apparatus for processing and recording an image onto said copy sheet traveling in a process direction; an image development apparatus for developing the image; a transfer device for transferring the image onto said copy sheet; a fuser for fusing the image onto said copy sheet, said fuser including a fuser roll and a pressure roll that forms a nip therebetween through which said copy sheet is conveyed in order to permanently fuse the image onto said copy sheet; a heater in said fuser roll comprising a dielectric resistive trace (DRT) flanked by conductive paths on either side in the process direction, wherein the conductive paths are printed on the substrate using conductive ink and wherein the DRT comprises resistive ink elements and a plurality of geometric shapes of dielectric material arranged on at least one of the resistive ink elements, wherein the DRT is divided into at least one or more segments, each of the segments coupled at one end by a single continuous conductive trace and on the other end by one of a multiple conductive traces that are connected at multiple contact points to said trace so as to provide heating for different paper widths; wherein the plurality of geometric shapes of dielectric material is added to a resistive ink element to increase the overall resistivity.

Example 2 includes the subject matter of Example 1, and wherein the plurality of geometric shapes of dielectric material forms a grid.

Example 3 includes the subject matter of Example 2, and wherein said resistive trace is configured to include at least three parallel segments.

Example 4 includes the subject matter of Example 1, and wherein conductivity of the resistive ink is varied to selectively control resistance of the resistive trace at each of the at least three parallel segments.

Example 5 includes the subject matter of Example 1, and wherein said multiple conductive traces comprise three or more conductive traces.

Example 6 includes the subject matter of Example 1, and wherein said multiple contact points to said resistive trace and multiple conductive traces comprise four or more contact points.

Example 7 includes the subject matter of Example 1, and wherein at each of the at least three parallel segments the resistance is substantially equal.

Example 8 includes the subject matter of Example 1, and including two or more resistive paths.

Example 9 includes an apparatus useful in printing including a fuser, said fuser comprising: a pressure roll; and a fuser roll that forms a nip therebetween through which a copy sheet is conveyed in order to permanently fuse an image onto said copy sheet, and wherein said fuser roll includes a heater having a single resistive trace configured so as to present segments of predetermined widths to accommodate multiple copy sheet sizes, and wherein multiple conductive traces are connected at multiple contact points to said resistive trace to facilitate independent control of said resistive trace and each of the segments; a plurality of geometric shapes of dielectric material arranged on at least one segment of the resistive trace; wherein the plurality of geometric shapes of dielectric material form a grid; wherein the dielectric material has a cross-sectional shape that is any of: circular, square, cylindrical, triangular or irregular.

Example 10 includes the subject matter of Example 9, and wherein said heater includes a single resistive trace and wherein said single resistive trace is configured as three or more parallel segments, wherein said fuser roll is made of a highly conductive ceramic material, wherein said resistive and conductive traces are mounted on a highly conductive ceramic material, wherein said multiple conductive traces comprise six conductive traces, and/or wherein said multiple contact points to said resistive trace and outer segments comprise six contact points.

Example 11 includes a printing machine adapted to print an image on a copy sheet, comprising: an imaging apparatus for processing and recording an image onto said copy sheets; an image development apparatus for developing the image; a transfer device for transferring the image onto said copy sheet; and a fuser for fusing the image onto said copy sheet, said fuser including a fuser roll and a pressure roll that forms a nip therebetween through which a copy sheet is conveyed in order to permanently fuse said image onto said copy sheet, and wherein said fuser roll includes a heater having a single resistive trace, and wherein said single resistive trace is contacted at multiple points by multiple conductive traces which divides said resistive trace into segments for heating copy sheets of different widths; a plurality of geometric shapes of dielectric material arranged on at least one segment of the resistive trace; wherein the plurality of geometric shapes of dielectric material form a grid; wherein the dielectric material has a cross-sectional shape that is any of: circular, square, cylindrical, triangular or irregular.

Although embodiments of the invention are not limited in this regard, discussions utilizing terms such as, for example, “processing”, “computing”, “calculating”, “determining”, “applying”, “receiving”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of resistors” may include two or more resistors.

The term “controller” is used herein generally to describe various apparatus relating to the operation of one or more device that directs or regulates a process or machine. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

The terms “print media” and “print sheet” generally refers to a usually flexible, sometimes curled, physical sheet of paper, plastic, or other suitable physical print media substrate for images, whether precut or web fed.

The term “printing device” or “printing system” as used herein refers to a digital copier or printer, scanner, image printing machine, xerographic device, electrostatographic device, digital production press, document processing system, image reproduction machine, bookmaking machine, facsimile machine, multi-function machine, or generally an apparatus useful in printing or the like and can include several marking engines, feed mechanism, scanning assembly as well as other print media processing units, such as paper feeders, finishers, and the like. A “printing system” can handle sheets, webs, marking materials, and the like. A printing system can place marks on any surface, and the like and is any machine that reads marks on input sheets; or any combination of such machines.

As used herein, the term “xerography” is understood as comprising a process producing at least one copy of an electrostatically charged image on a substrate or carrier, i.e., a sheet of paper. Xerography is then any printing operation in which marking material, typically but not necessarily a dry toner, associated with one or more images is transferred to a copy sheet (print sheet) by electrostatic forces in a printing system.

For illustrative purposes, although the term “fuser” is used herein throughout the application, it is intended that the term “fuser” also encompasses members useful for a printing process or in a printing system including, but not limited to, a fixing member, a pressure member, a heat member, and/or a donor member. In various embodiments, the fuser can be in a form of, for example, a roller, a cylinder, a belt, a plate, a film, a sheet, a drum, a drelt (cross between a belt and a drum), or other known form for a fuser member. A “fuser”, as described and claimed herein, may be adapted to be useful in other types of printing, such as solid-inkjet printing, iconography, xerography, flexography, offset printing, and the like.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

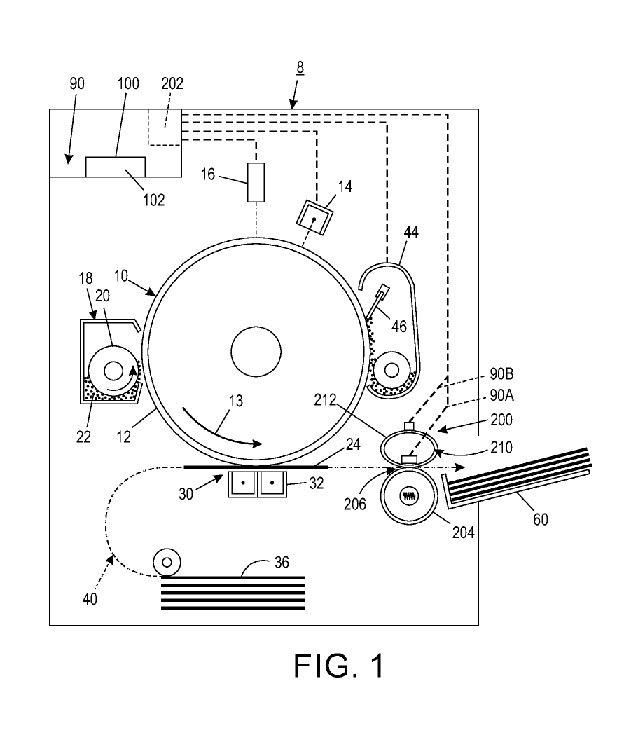

FIG. 1 is an elevational view showing relevant elements of an exemplary toner imaging electrostatographic machine including a first embodiment of the fusing apparatus of the present disclosure.

Referring now to FIG. 1, an electrostatographic or toner-imaging machine 8 is shown. As is well known, a charge receptor or photoreceptor 10 having an imageable surface 12 and rotatable in a direction 13 is uniformly charged by a charging device 14 and imagewise exposed by an exposure device 16 to form an electrostatic latent image on the surface 12. The latent image is thereafter developed by a development apparatus 18 that, for example, includes a developer roll 20 for applying a supply of charged toner particles 22 to such latent image. The developer roll 20 may be of any of various designs, such as, a magnetic brush roll or donor roll, as is familiar in the art. The charged toner particles 22 adhere to appropriately charged areas of the latent image. The surface of the photoreceptor 10 then moves, as shown by the arrow 13, to a transfer zone generally indicated as 30. Simultaneously, a print sheet 24 on which a desired image is to be printed is drawn from sheet supply stack 36 and conveyed along sheet path 40 to the transfer zone 30.

At the transfer zone 30, the print sheet 24 is brought into contact or at least proximity with a surface 12 of photoreceptor 10, which at this point is carrying toner particles thereon. A corotron or other charge source 32 at transfer zone 30 causes the toner image on photoreceptor 10 to be electrostatically transferred to the print sheet 24. The print sheet 24 is then forwarded to subsequent stations, as is familiar in the art, including the fusing station having a high precision-heating and fusing apparatus 200 of the present disclosure, and then to an output tray 60. Following such transfer of a toner image from the surface 12 to the print sheet 24, any residual toner particles remaining on the surface 12 are removed by a toner image baring surface cleaning apparatus 44 including a cleaning blade 46 for example.

As further shown, the reproduction machine 8 includes a controller or electronic control subsystem (ESS), indicated generally by reference numeral 90 which Is preferably a programmable, self-contained, dedicated mini-computer having a central processor unit (CPU), electronic storage 102, and a display or user interface (UI) 100. At UI 100, a user can select one of the pluralities of different predefined sized sheets to be printed onto. The conventional ESS 90, with the help of sensors, a look-up table 202 and connections, can read, capture, prepare and process image data such as pixel counts of toner images being produced and fused. As such, it is the main control system for components and other subsystems of machine 8 including the fusing apparatus 200 of the present disclosure.

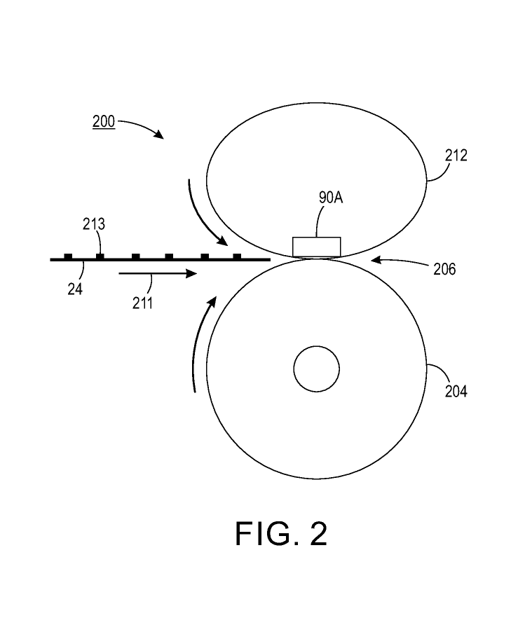

FIG. 2 is an enlarged schematic end view of the fusing apparatus of FIG. 1.

Referring now to FIG. 2, the fusing apparatus 200 of the present disclosure is illustrated in detail and is suitable for uniform and quality heating of unfused toner images 213 in the electrostatographic reproducing machine 8. As illustrated, fusing apparatus 200 includes a rotatable pressure member 204 that is mounted forming a fusing nip 206 with a highly conductive ceramic fuser roll member 210. Heater 90A is positioned in contact with the inner diameter of fuser roll belt 210. Heater 90B is optional as required by design configuration. A copy sheet 24 carrying an unfused toner image 213 thereon can thus be fed in the direction of arrow 211 through the fusing nip 206 for high quality fusing.

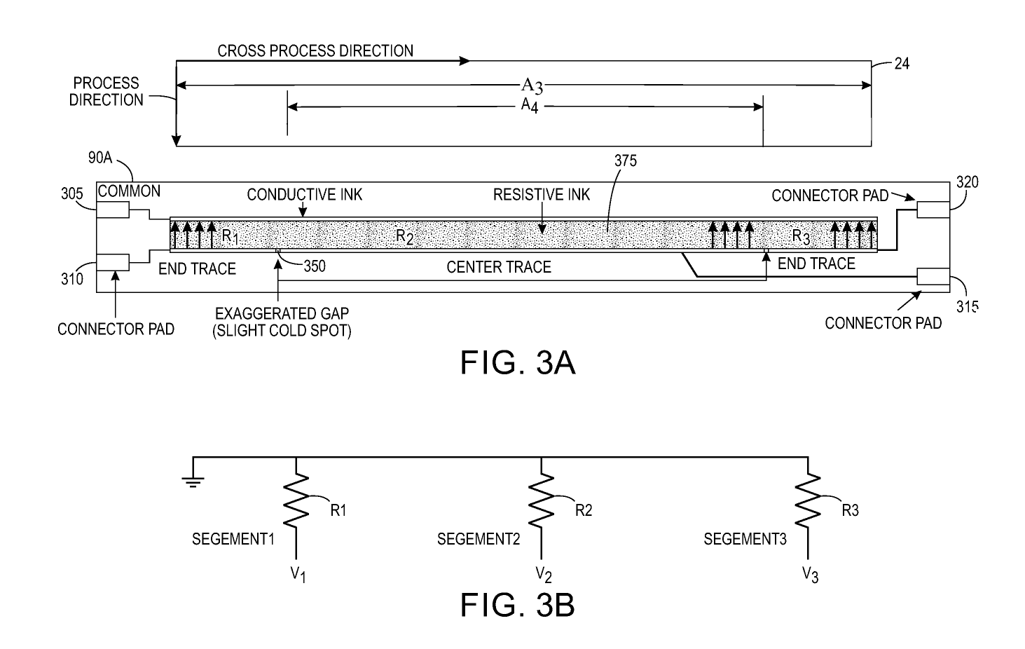

FIG. 3A is partial plan view of the heater portion of the first embodiment of the improved fuser of FIG. 2 that employs a independently controllable resistive trace flanked by conductive paths on either side in the process direction. The heater portion is a resistive ink-based that includes a plurality of electrically resistive ink-based segments generally labeled as end and center traces. Elaborating on the above description, the heater which is produced has both an electrically conductive ink layer and an electrically resistive ink layer. The conductive ink layer is selectively applied in a pattern to electrically short out portions of the resistive ink layer (labeled common and end traces), thereby permitting the heater to have a predetermined resistive taper across its width or length according to a desired resistivity curve. The conductive ink layer is applied in a pattern of shapes, preferably rectangles, and the resistive ink layer is applied in a sheet which forms a grid-like pattern of lines bordering and separating the conductive shapes. The space or gap 350 between shapes is so narrow that to all intents and purposes the resistive ink layer can be considered as one contiguous element. A slight cold spot is developed at gap 350 but due to its miniscule dimension it does not produce a noticeable difference in heating.

One type of resistive ink-based radiant heater 90A is printed with a carbon-based ink having a variety of resistances. Another type of resistive ink-based radiant heater 90A is printed with silver-containing inks having a variety of resistances. Yet another conductive ink-based radiant heater 90A is a circuit printed onto a polyester film. In the first embodiment the heater is made by a resistive trace of uniform resistance.

A heater configuration is shown in FIG. 3A uses a multiple segment design which provides system thermal control across all paper sheet widths along the process direction. In FIG. 3B the simplified electrical schematic equivalent circuit for the heater of FIG. 3A is modeled as having three resistive segments R1, R2, and R3 each connected electrically to a common contact pad and the second contact pad to a voltage driver (V1, V2, and V3). This configuration includes a single resistive element consisting of a resistive trace 375 flanked by conductive paths (for example, end and center traces) on either side in the process direction. On one end is a single continuous conductive trace referred two as the common. On the other end are three or more separate conductive traces to allow heating for different paper widths like widths corresponding to paper sheet 24 corresponding to A3, A4 and the like. The symmetrical non-centered conductive traces (end traces) may be tied together either within the fuser harnessing or within the element in a different vertical layer so as to limit the number of pins needed in the fuser drawer connector. There would be a small cold spot 350 between the end and center conductive traces, but this area would be smaller than in current tap in designs as this gap is controlled in one trace mask as compared to present “tap in” designs which require cold spots three times (3×) greater than provided by this design. It can be seen that the heater is heated by applying voltage to one of three taps V1, V2, V3 at connector pads 310, 315, 320 along the resistive trace comprised of R1, R2 and R3. Connector pad 305 is maintained at a common voltage such as 0 volts.

As shown, heater 90A has a plurality of predefined sized fusing areas a first end trace, a center trace, and second end trace and with each one of the fusing areas being selectively activatable by controller 90. The illustrated fusing areas are arranged in a substantially parallel manner along a cross process direction of fuser belt 210. Controller 90 activating one or more of fusing areas by applying one or more voltages at connector pads to correspond to sized sheet entering the fusing device 200. For example the width of fusing area at center trace when activated may correspond to A4 sized paper while the width of predefined sized fusing area end trace when activated may correspond to smaller width paper such as A4 and the like. The design could be extended to include additional zones by segmenting a trace into smaller traces that can accommodate a desired paper size. For example, the center trace can be segmented into two regions that collectively can accommodate an A4 sized paper (shown) or an A6 sized paper at each segment. As can be seen, the heater 90A can be independently controlled in a center registered single heating trace configuration or an end trace configuration. Further, the width of predefined sized fusing area center and end traces when activated may correspond to A3 sized paper.

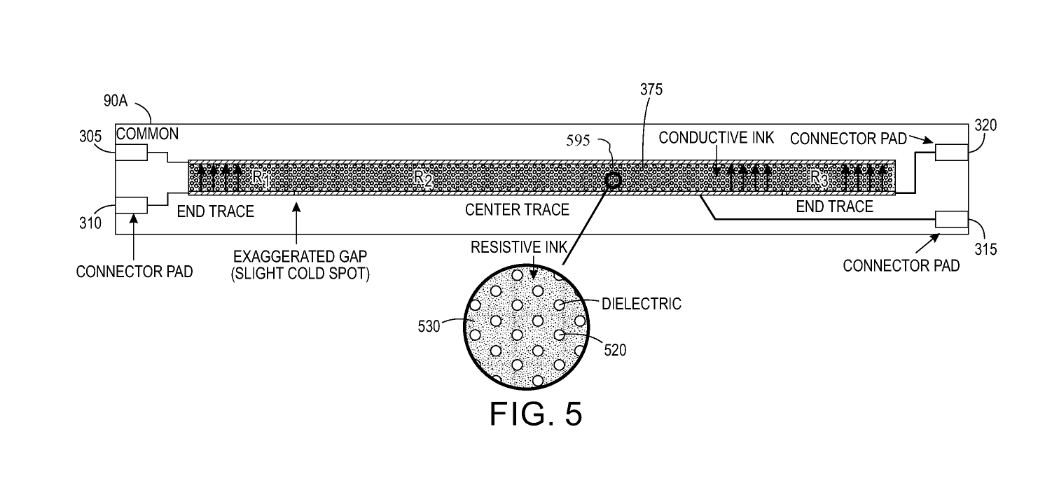

Resistive trace 375 is mounted on a ceramic substrate or other suitable structure that can accommodate a heating element. Resistive trace 375 is printed resistance. The printed trace is made from resistive ink that is deposited on a print layout on the ceramic substrate. A variety of electrical elements can be printed with electrically functional inks; such elements can be fashioned to exhibit certain dielectric, resistive, conductive, and semiconductive properties. The trace is manufactured with resistive ink and the conductive paths with conductive ink. As a general rule, printed resistance can be defined as follows: R=Ω(L/A) where R=resistance; Ω=bulk resistivity of the ink or resistance per unit volume; L=length of resistor ink; and A=cross sectional area of the resistor ink. The cross-sectional area of the resistor ink in turn equals the product of the print thickness (T) and the width (W) of the resistor ink. Substituting these parameters yields the following formula for the resistance of a printed resistor: R=Ω(L/TW). Thus, the resistance of a printed resistor is a function of the bulk resistivity of the ink used to print the resistor, the length (L) of the resistor ink, the thickness (T) of the printed resistor ink and the width (W) of the printed resistor ink. Resistors having different resistances can thus be formulated by varying any of these parameters (L, T, or W). Resistors can be fashioned to include dielectric and/or semiconductive properties like shown in FIGS. 5, 6, and 7.

A single resistive ink could be used to make a resistor having a desired length and ohmic value, but this would require very large and long resistor layouts to print high-ohm resistors. A preferred method for fabricating resistors is to print resistors consisting of multiple resistive inks However, for each additional resistive ink used, there are additional processing costs, due to the need for additional printing stations, and added complexity to a layout. Processing costs can be mitigated by a procedure that selects plurality of inks such that when blended in a predetermined proportion, the resistivity of the blended ink is optimized, based on the target resistance value and a desired dimensional layout of the ink upon the substrate.

FIG. 3B is a schematic of a resistive trace flanked by conductive paths on either side in the process direction in accordance to an embodiment. FIG. 3B is a schematic diagram of a segmented single resistive trace wherein Segment 1, Segment 2 and Segment 3 correspond respectively to heating regions enumerated in FIG. 3A. It can be seen that the heater is heated by applying voltage to one of three taps V1, V2, V3 along the resistive trace comprised of R1, R2 and R3. Because of the length, resistive ink used, and the voltage applied each segment will have its own power density per unit length (“W/mm”). The voltage tap are selected by a control algorithm based on paper size (A1, A2, A3, and the like), paper thickness, and other attributes known to those in the art.

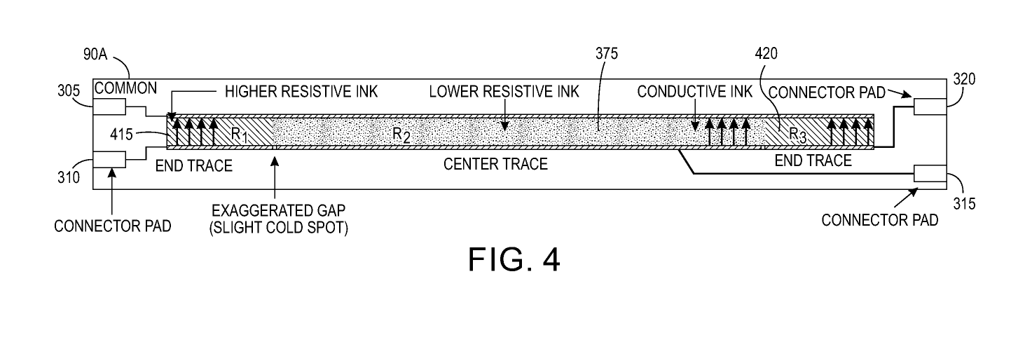

FIG. 4 is partial plan view of the heater portion of a single resistive trace having segments of same or varying resistance to heat different paper widths in accordance to an embodiment.

Next, a second embodiment of the present invention will be described. Note that portions which are the same as those in the first embodiment described above are denoted by the same reference numerals, and descriptions of the same portions as those as in the first embodiment will be omitted. In the illustrated embodiment the length and width of the resistive trace is unchanged, the thickness of the applied resistive ink is changed to provide a solid heater with different resistances in different heating areas. The resistive trace 375 is shown with first end trace 415 and second end trace 420 having a higher /lower amount of resistive ink or thicker/thinner printed resistor relative to the resistive ink used in FIG. 3A. As a result the power density of R1 at FIG. 4 is higher/lower than R1 at FIG. 3A. Note that the center trace does not include a higher resistive ink so it remains unchanged. However, it should be noted that because the center trace is relative longer than the end traces 415 or 420 (i.e., assuming equivalent ink composition) it could still have a higher resistance (R) value.

FIG. 5 is partial plan view of the heater portion of a single resistive trace infused with a dielectric to increase overall resistance in accordance to an embodiment. Note that portions which are the same as those in the previous embodiments described above are denoted by the same reference numerals, and descriptions of the same portions as those as in the previous embodiments will be omitted. As illustrated the resistive trace 375 is shown composed of resistive ink (530) and augmented with a dielectric (520) to form a dielectric resistive trace (DRT) 595. In one technique after dielectric is formed, a thick film resistive circuit using silk screen printed over the dielectric layer. In another technique, the ink resistive trace is first formed and the dielectric material is applied on part or the entire surface of the resistive trace. The dielectrics 520 have a plurality of geometric shapes of dielectric material arranged or distributed to form a grid. The dielectric material has a cross-sectional shape that is any of: circular, square, cylindrical, triangular or irregular. Resistive ink infused with dielectric material produces a segment with overall resistance that has been increased allowing for the use of lower resistance ink (530) that vendors can more repeatedly produce. Rows of dielectric (520) can be offset from one another to insure overall thermal uniformity. Again, this enables the use of easier to manufacture low resistance inks The principle could also be reversed with grids of small conductive circles if lower resistance was desired.

Elaborating on the above description, ceramic substrate or other suitable structure that can accommodate the resistive trace 375 is prepared with resistive ink deposited in the desired pattern with any number of conventional. For example, syringe deposition may be used on target objects that are unsuitable for screen printing, such as those with geometries such as disk-like triangles or trapezoids, segments of circles, circular, triangular or the like. Spraying such as plasma sprayed coating is also appropriate for use with the present embodiment. Thinner and thioxtropic forming agent can also be added to the dielectric to make it suitable for deposition using commonly known silk screening techniques. While dielectric material is shown as being applied to the whole resistive trace 375 it should be noted that different applications such as adding dielectric material to only certain segments of the trace are envisioned without departing from the scope of the invention.

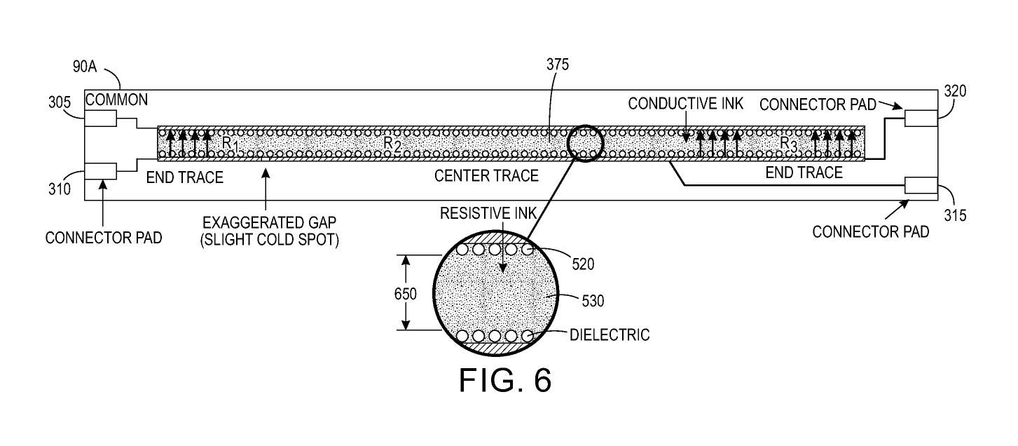

FIG. 6 is partial plan view of the heater portion of a single resistive trace infused with a dielectric at the top and bottom of the heating zone to increase overall resistance in accordance to an embodiment; single high voltage level. Resistance at the top and bottom of the heating zone has been increased relative to the middle by placing the dielectric 520 at the top and bottom and leaving a middle layer 650 of resistive ink 530. This compensates for bleed off to the substrate and creates a more uniform temperature in the heating zone. Again portions which are the same as those in the previous embodiments described above are denoted by the same reference numerals.

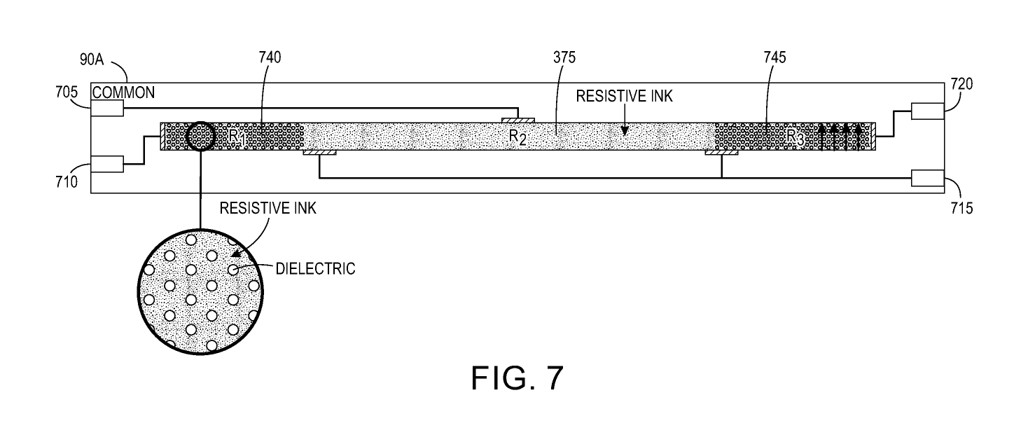

FIG. 7 is partial plan view of the heater portion of a single resistive trace infused with a dielectric configured to produce single high voltage level in accordance to an embodiment. Note that portions which are the same as those in the previous embodiments described above are denoted by the same reference numerals, and descriptions of the same portions as those as in the previous embodiments will be omitted. The difference in configuration between the embodiment of FIG. 3A and the embodiment of FIG. 7 is that in this embodiment the heater portion can accommodate cross process direction heating of the element. If a single high voltage level is desired many designs require either multiple resistive inks or large variations in heating area width. With a dielectric grid these different resistances can be obtained with just one resistive ink. As shown, the resistive trace 375 has dielectric portions at the first end trace 740 and the second end trace 745. The dielectric portion could be added to the center trace if one desires to have differences in resistance at that part of the resistive trace. Having a dielectric portion creates a trace where overall resistance has been increased (center or end traces) allowing for the use of lower resistance ink.

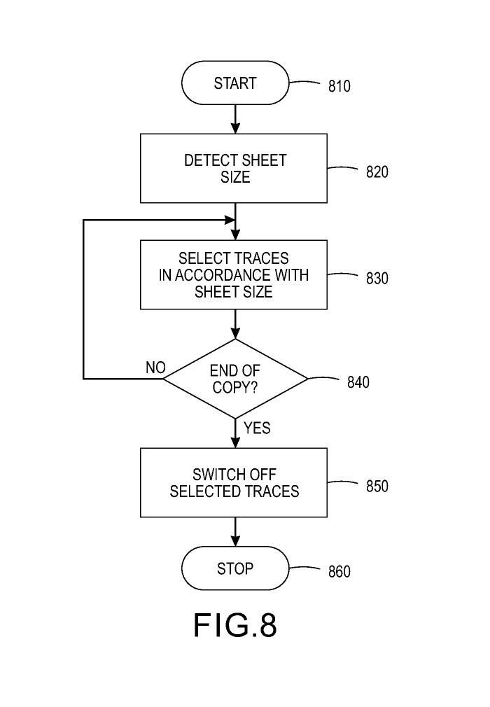

FIG. 8 illustrates a flowchart of a method to control heat generating segments of the resistive trace in accordance to an embodiment. The method begins at start 810 command such as the print command or the powering of the heater element (90A or 90B). In action 820 the sheet size is detected or media attribute such as size, weight, color, coating, transparency, and the like is sensed or provided by an operator. Control is then passed to action 830 where the traces are selected for activation or for increased in voltage by controller 90. Action 830 selects the traces such as end traces or center trace that are necessary based on the media attribute acquired in action 820. Control is then passed to action 840 where the action of selecting traces is repeated until the print job is completed such as when reaching the last copy in a copying process. Control is then passed to action 850 where the selected traces are switched off. The method is then stopped at action 860 since heating is no longer required or if the heater is to be operated at a power saving mode such as standby and the like.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

In recapitulation, the embodiments of the present disclosure address a problem of current center registered solid heaters either require multiple heating traces or inter heating trace conductive taps. Multiple heating traces hurt heat transfer performance and thus extendibility. Designs with inter heating trace conductive taps have cold spots that effect/hurt latitudes and require bigger drawer connectors with extra pins. Present center registered single heating trace designs require either serial control or perfect knowledge of media widths.

Embodiments of the present disclosure address the problem of solid heaters often requiring different resistances in different heating areas. This can lead to non-optimal placement of the heating element for heat transfer and require larger (more expensive) substrates. Solid heaters provide no method for varying resistance within a heating zone. Embodiments are disclosed where Grids of small dielectric circles can be added to resistive heating zones to increase the overall resistivity. Rows of dielectric can be offset from one another to insure overall thermal uniformity.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A xerographic device adapted to print an image onto a copy sheet, comprising:
an imaging apparatus for processing and recording an image onto said copy sheet traveling in a process direction;
an image development apparatus for developing the image;
a transfer device for transferring the image onto said copy sheet;
a fuser for fusing the image onto said copy sheet, said fuser including a fuser roll and a pressure roll that forms a nip therebetween through which said copy sheet is conveyed in order to permanently fuse the image onto said copy sheet; and
a heater in said fuser roll comprising a dielectric resistive trace (DRT) flanked by conductive paths on either side in the process direction, wherein the conductive paths are printed on a substrate using conductive ink;
wherein the DRT comprises resistive ink elements and a plurality of geometric shapes of dielectric material arranged on at least one of the resistive ink elements;
wherein the DRT comprises at least one or more segments, each of the segments coupled at one end by a single continuous conductive trace and on the other end by one of a multiple conductive traces that are connected at multiple contact points to said trace so as to provide heating for different paper widths;
wherein the plurality of geometric shapes of dielectric material form a grid;
wherein the heater comprise two or more resistive paths;
wherein the plurality of geometric shapes of dielectric material is added to a resistive ink element to increase the overall resistivity.

2. (canceled)

3. The xerographic device of claim 1, wherein said DRT is configured to include at least three parallel segments and wherein the dielectric material has a cross-sectional shape that is any of: circular, square, cylindrical, triangular or irregular.

4. The xerographic device of claim 3, wherein conductivity of the resistive ink is varied to selectively control resistance of the resistive trace at each of the at least three parallel segments.

5. The xerographic device of claim 4, wherein said multiple conductive traces comprise three or more conductive traces.

6. The xerographic device of claim 5, wherein said multiple contact points to said DRT and multiple conductive traces comprise four or more contact points.

7. The xerographic device of claim 4, wherein at each of the at least three parallel segments the resistance is substantially equal.

8. (canceled)

9. A fuser for an apparatus useful in printing, said fuser comprising:
a pressure roll; and
a fuser roll that forms a nip therebetween through which a copy sheet is conveyed in a process direction in order to permanently fuse an image onto said copy sheet;
wherein said fuser roll includes a heater having a single resistive trace configured so as to present segments of predetermined widths to accommodate multiple copy sheet sizes;
wherein multiple conductive traces are connected at multiple contact points to said resistive trace to facilitate independent control of said resistive trace and each of the segments;
wherein the multiple conductive traces form conductive paths on either side of the single resistive trace in the process direction;
wherein the single resistive trace is printed on a substrate using a resistive ink; and
a plurality of geometric shapes of dielectric material arranged on at least one segment of the resistive trace;
wherein the plurality of geometric shapes of dielectric material form a grid;
wherein the plurality of geometric shapes of dielectric material is added to the resistive ink to increase the overall resistivity;
wherein the dielectric material has a cross-sectional shape that is any of: circular, square, cylindrical, triangular or irregular;
wherein said resistive and conductive traces are mounted on a highly conductive ceramic material;
wherein said multiple contact points to said resistive trace and outer segments comprise four contact points.

10. The fuser of claim 9, wherein said heater includes a single resistive trace and wherein said single resistive trace is configured as three or more parallel segments.

11. The fuser of claim 10, wherein said fuser roll is made of a highly conductive ceramic material.

12. (canceled)

13. The fuser of claim 10, wherein said multiple conductive traces comprise four conductive traces.

14. (canceled)

15. A printing machine adapted to print an image on a copy sheet, comprising:
an imaging apparatus for processing and recording an image onto said copy sheets;
an image development apparatus for developing the image;
a transfer device for transferring the image onto said copy sheet; and
a fuser for fusing the image onto said copy sheet, said fuser including a fuser roll and a pressure roll that forms a nip therebetween through which a copy sheet is conveyed in a process direction in order to permanently fuse said image onto said copy sheet, and wherein said fuser roll includes a heater having a single resistive trace, and wherein said single resistive trace is contacted at multiple points by multiple conductive traces which divides said resistive trace into segments for heating copy sheets of different widths;
wherein the multiple conductive traces form conductive paths on either side of the single resistive trace in the process direction;
wherein the single resistive trace is printed on a substrate using a resistive ink; and
a plurality of geometric shapes of dielectric material arranged on at least one segment of the resistive trace;
wherein the plurality of geometric shapes of dielectric material form a grid;
wherein the plurality of geometric shapes of dielectric material is added to the resistive ink to increase the overall resistivity;
wherein the dielectric material has a cross-sectional shape that is any of: circular, square, cylindrical, triangular or irregular;
wherein said resistive trace is contacted at four points by said multiple conductive traces;
wherein said single resistive trace and said conductor traces are mounted on a ceramic substrate.

16. (canceled)

17. The printing machine of claim 15, wherein cold spot compensation is negated by providing energy inline with said multiple conductive trace junctions.

18. The printing machine of claim 15, including dual resistive paths.

19. (canceled)

20. (canceled)
